(19) United States
(12) Patent Application Publication
(10) Pub. No.: US 2013/0124061 A1
(43) Pub. Date: May 16, 2013

(54) SYSTEM AND METHOD FOR DETERMINING A SPEED OF A VEHICLE

(71) Applicant: GM GLOBAL TECHNOLOGY OPERATIONS LLC, Detroit, MI (US)

(72) Inventors: Ali Khanafer, Mainz (DE); Nikolas Wagner, Eltville-Rauenthal (DE); Christoph Ferber, Alsheim (DE)

(73) Assignee: GM GLOBAL TECHNOLOGY OPERATIONS LLC, Detroit, MI (US)

(21) Appl. No.: 13/670,518

(22) Filed: Nov. 7, 2012

(30) Foreign Application Priority Data
Nov. 10, 2011 (DE) 10 2011 118 147.8

(51) Int. Cl. G06F 17/00; H04N 7/18

(52) U.S. Cl. CPC G06F 17/00; H04N 7/18
USPC 701/70; 701/1; 348/148

(57) ABSTRACT

A method for determining a speed of a vehicle, is provided. The method includes determining if at least one object is sensed by at least one sensor of the vehicle. In the case that at least one object is sensed by the at least one sensor, the method includes determining if the at least one sensed object is locationally fixed by means of data determined by at least one optical camera of the vehicle. In the case that it is determined that the at least one sensed object is locationally fixed, the method includes determining a speed of the at least one sensed object relative to the vehicle by means of data determined by the at least one sensor and classifying the determined speed as individual speed of the vehicle.

### CROSS-REFERENCE TO RELATED APPLICATION

This application claims priority to German Patent Application No. 10 2011 118 147.8, filed Nov. 10, 2011, which is incorporated herein by reference in its entirety.

### TECHNICAL FIELD

The present disclosure relates to a method for determining a speed of a vehicle, a vehicle, a computer program product and a computer-readable medium.

### BACKGROUND

From DE 198 60 633 A1 a method and a device for measuring the speed of a vehicle relative to a road surface is known. In order to increase the accuracy of the speed measurement and in order to be able to determine the speed of the vehicle independently of the diameter and the grip of a vehicle wheel on the road surface, speed of the vehicle is directly measured on the road surface utilizing the Doppler effect.

Accordingly, it may be desirable to provide a method for determining a speed of a vehicle, a vehicle, a computer program product and a computer-readable medium which make possible a further-improved determination of the speed. In addition, other objects, desirable features and characteristics will become apparent from the subsequent summary and detailed description, and the appended claims, taken in conjunction with the accompanying drawings and this background.

### SUMMARY

According to one of various aspect of the present disclosure, a method for determining a speed of a vehicle is provided. The method includes determining if at least one object is sensed by at least one sensor of the vehicle. If at least one object is sensed by the at least one sensor, the method includes determining if the at least one sensed object is locationally fixed by means of data determined by at least one optical camera of the vehicle. If it is determined that the at least one sensed object is locationally fixed, the method includes determining a speed of the at least one sensed object relative to the vehicle by means of data determined by the at least one sensor and the method includes classifying the determined speed as individual speed of the vehicle.

Throughout this disclosure, a locationally fixed object is to mean that the object is stationary or fixed with respect to the surface or a road on which the vehicle travels.

The method according to an exemplary embodiment makes possible a further improved determining of the speed of the vehicle by means of vehicle-based sensors, which can also be called environment sensors here. This takes place through the determining if a sensed object is locationally fixed, by means of data determined by at least one optical camera of the vehicle and the determining of the speed of the sensed object classified as individual speed relative to the vehicle by means of data determined by the at least one sensor. The basis here is the consideration that a classifying of objects with respect to whether these are locationally fixed or stationary can be effected in a simple and reliable manner by means of data of the optical camera. In addition, such optical cameras are increasingly provided for vehicles, as a result of which the number of components needed for the method can be reduced in an advantageous manner.

The at least one sensor is generally selected from the group comprising a radar sensor, a lidar sensor and an ultrasound sensor. By means of data determined by such runtime-based sensors the speed of the sensed object relative to the vehicle can be determined in a highly precise manner, in one example by utilizing the Doppler effect. Because of this, accuracies can be achieved which for example in the case of radar sensors are typically in the range of 0.1 m/s independently of the speed of the individual vehicle.

In an exemplary embodiment, the determining if the at least one sensed object is locationally fixed takes place based on an image evaluation of images taken by means of the at least one optical camera. The image evaluation in this case generally includes a determining of a size and/or a change of the size of the at least one object in the images taken by the at least one optical camera. Because of this, upon a change in size in the form of a component of the object in the pictures taken that becomes larger, a locationally fixed or stationary object can be typically inferred.

In another exemplary embodiment of the method, the determined speed is provided for at least one driver assistance system of the vehicle. This makes possible in an advantageous manner an operation of the driver assistance system based on the individual speed of the vehicle determined to a precise degree.

The at least one driver assistance system in this case is generally selected from the group comprising a tire pressure monitoring system, a park assist system, a brake assist, an emergency braking system, a speed control system and a distance control system. With the mentioned driver assistance systems, the most accurate knowledge possible of the current individual speed of the vehicle is of particular importance. By means of the mentioned method for determining the speed of the vehicle, an operation of the mentioned driver assistance systems based on an incorrectly or inaccurately determined speed of the vehicle can be advantageously avoided.

In another exemplary embodiment, in which the at least one driver assistance system is embodied as tire pressure monitoring system, a determining of a speed of the vehicle based on data determined by at least one rotational speed sensor of a tire of the vehicle takes place. Here, a warning message is generally output in the case that a deviation between the speed determined by means of the at least one sensor and the speed determined by means of the at least one rotational speed sensor exceeds a predetermined threshold value. This is based on the consideration that a determining of the speed based on the wheel rotational speed signals, i.e. based on a measurement of the wheel speed in conjunction with a determining of the speed based on the measured environment sensor data can be utilized for an indirect tire pressure measurement, in one example in order to detect a pressure drop in the tires by means of the redundant speed variable, i.e. by means of the speed determined by means of the at least one environment sensor.

In another exemplary embodiment of the method, a determining of a direction and/or of a distance of the at least one sensed object relative to the vehicle takes place by means of data determined by the at least one sensor and by means of the at least one optical camera. Furthermore, a fusion and plausibility audit of the determined data takes place. Thus, an allocation of the determined data of the sensor and of the optical camera to the same sensed object can take place in a reliable manner.

The determining if the at least one sensed object is locationally fixed can additionally take place based on data received from a vehicle-to-infrastructure communication device and/or a vehicle-to-vehicle communication device. This is based on the consideration that the position data of locationally fixed or stationary objects, for example of so-called road side infrastructure devices, which are also designated RSU (road side unit), can also be transmitted to the vehicle by means of vehicle-to-infrastructure communication or vehicle-to-vehicle communication and from the transmitted data it can be determined if the sensed object is a locationally fixed object.

The present disclosure furthermore relates to a vehicle having a first determining device, which is designed for determining if at least one object is sensed by at least one sensor of the vehicle. In addition, the vehicle comprises at least one optical camera. Furthermore, the vehicle comprises a second determining device designed for determining if a sensed object is locationally fixed, by means of data determined by the at least one optical camera in the case that at least one object is sensed by the at least one sensor. In addition to this, the vehicle comprises a third determining device, which is designed for determining a speed of the at least one sensed object by means of data determined by the at least one sensor. Furthermore, the vehicle comprises a classification device which is designed for classifying the determined speed as individual speed of the vehicle if it is determined that the at least one sensed object is locationally fixed.

The vehicle according to the present disclosure has the advantages already mentioned in connection with the method according to the present disclosure, which at this point are not mentioned again to avoid repetitions.

Generally, the at least one sensor is selected from the group comprising a radar sensor, a lidar sensor and an ultrasound sensor.

In addition, the vehicle in an exemplary embodiment comprises at least one driver assistance system, selected from the group comprising a tire pressure monitoring system, a park assist system, a brake assist, an emergency braking system, a speed control system and a distance control system. The at least one driver assistance system in this case is designed for an operation based on the speed determined by means of the third determining device.

Generally, the vehicle is a motor vehicle, in one example a passenger car or a commercial motor vehicle.

Furthermore, the present disclosure relates to a computer program product which, when it is executed on a computer unit of a vehicle, instructs the computer unit to carry out the following method. The computer unit is instructed to determine if at least one object is sensed by at least one sensor of the vehicle. If at least one object is sensed by the at least one sensor, the computer unit is instructed to determine if the at least one sensed object is locationally fixed by means of data determined by at least one optical camera of the vehicle. If it is determined that the at least one sensed object is locationally fixed, the computer unit is instructed furthermore to determine a speed of the at least one sensed object relative to the vehicle by means of data determined by the at least one sensor and for classifying the determined speed as individual speed of the vehicle.

In addition to this, the present disclosure relates to a computer-readable medium on which a computer program product according to the mentioned exemplary embodiment is stored.

The computer program product and the computer-readable medium according to the present disclosure have the advantages already mentioned in connection with the method according to the present disclosure, which at this point are not mentioned again in order to avoid repetitions.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a flow diagram of a method for determining a speed of a vehicle according to an exemplary embodiment of the present disclosure;

FIG. 2 shows a flow diagram of a method for determining a speed of a vehicle according to another exemplary embodiment of the present disclosure;

FIG. 3 shows a flow diagram of a method for determining a speed of a vehicle according to another exemplary embodiment of the present disclosure;

FIGS. 4 to 6 show examples of traveling situations, in which the method according to the present disclosure can be employed; and

FIG. 7 shows a schematic representation of a vehicle according to an exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

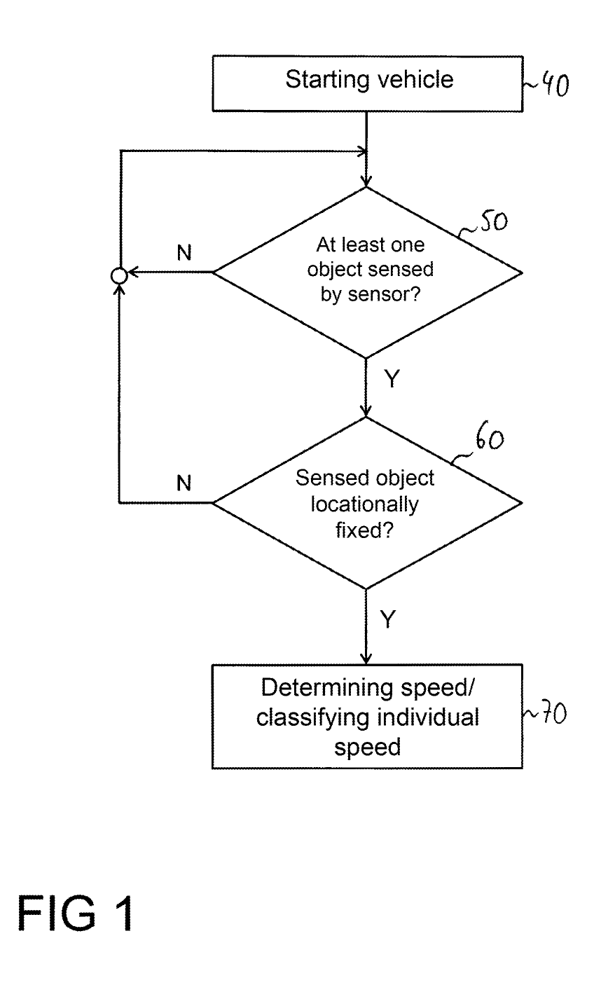

FIG. 1 shows a flow diagram of a method for determining a speed of a vehicle according to an exemplary embodiment of the present disclosure. The vehicle is for example a motor vehicle, in one example a passenger car or a commercial motor vehicle.

In 40, the vehicle is started, wherein in the shown exemplary embodiment additionally at least one sensor of the vehicle, which is generally selected from the group comprising a radar sensor, a lidar sensor and an ultrasound sensor, and at least one optical camera of the vehicle are activated. The at least one sensor in this case is designed for sensing objects within a first sensing range and the at least one optical camera for sensing objects within a second sensing range, wherein the first sensing range and the second sensing range at least partially overlap one another.

In 50 it is determined if at least one object is sensed by at least one sensor of the vehicle.

If no object is sensed by the at least one sensor, 50 is carried out repeatedly.

If, by contrast, at least one object is sensed by the at least one sensor, a determining if the at least one sensed object is locationally fixed takes place in 60. This takes place by means of data determined by the at least one optical camera of the vehicle. The determining if the at least one sensed object is locationally fixed typically takes place based on an image evaluation of images taken by means of the at least one optical camera. The image evaluation in this case generally includes a determining of a size of the at least one object in the images taken by the at least one optical camera, in one example a change of the size of the at least one object in the pictures taken.

Furthermore, the determining if the at least one sensed object is locationally fixed can additionally take place based on data received from a vehicle-to-infrastructure communication device and/or a vehicle-to-vehicle communication device.

If it is determined in 60 that the sensed object is not locationally fixed, 50 and if applicable 60 are carried out repeatedly.

If however it is determined in the 60 that the at least one sensed object is locationally fixed, a determining of the speed of the at least one sensed object relative to the vehicle by means of data determined by the at least one sensor and a classifying of the determined speed as individual speed of the vehicle take place.

In another exemplary embodiment, the determining of the speed of the at least one sensed object takes place even before the determining if said object is locationally fixed, i.e. between 50 and 60. In such a configuration the speed already determined previously is classified as individual speed of the vehicle in 70.

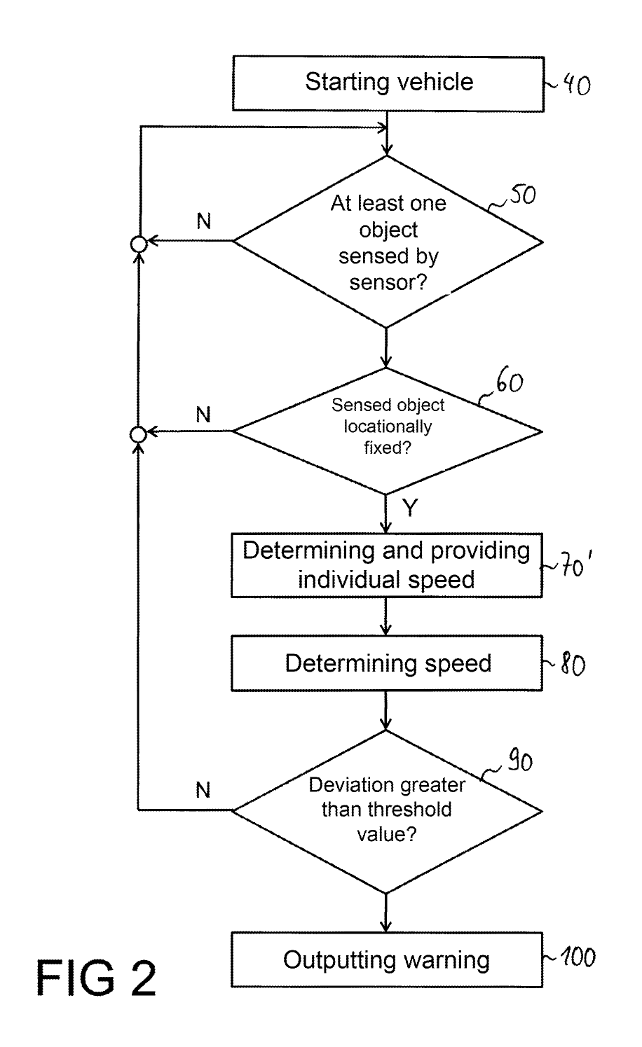

FIG. 2 shows a flow diagram of a method for determining a speed of a vehicle according to another exemplary embodiment of the present disclosure. The vehicle for example is again a passenger car.

In 40 the vehicle is started and at least one sensor and at least one optical camera of the vehicle activated, corresponding to 40 of the exemplary embodiment shown in FIG. 1.

In 50 it is determined if at least one object is sensed by at least one sensor of the vehicle, corresponding to 50 of the exemplary embodiment shown in FIG. 1.

If no object is sensed by the at least one sensor, 50 is carried out repeatedly.

If by contrast it is determined in 50 that at least one object is sensed by the at least one sensor, a determining if the at least one sensed object is locationally fixed takes place in 60. This takes place by means of data determined by the at least one optical camera of the vehicle, corresponding to 60 of the exemplary embodiment shown in FIG. 1.

If it is determined in 60 that the sensed object is not locationally fixed, 50 and if applicable 60 are carried out repeatedly.

If by contrast it is determined in 60 that the at least one sensed object is locationally fixed, a determining of a speed of the at least one sensed object relative to the vehicle by means of data determined by the at least one sensor and a classifying of the determined speed as individual speed of the vehicle take place. In addition, the determined speed in 70′ is provided in the shown exemplary embodiment for a tire pressure monitoring system of the vehicle. In addition to this, the determined speed can be provided for at least one further driver assistance system of the vehicle, wherein this is generally selected from the group comprising a park assist system, a brake assist, an emergency braking system, a speed control system and a distance control system.

In 80, a determining of a speed of the vehicle based on data determined by means of a rotational speed sensor of the tire of the vehicle takes place in the shown exemplary embodiment. The at least one rotational speed sensor in this case is part of the tire pressure monitoring system of the vehicle.

In 90 it is determined if a deviation between the speed determined by means of the at least one sensor and the speed determined by means of the at least one rotational speed sensor exceeds a predetermined threshold value. It is determined for example if the determined speed values deviate by more than about 5% from one another.

In the case that the deviation does not exceed the predetermined threshold value, 50 and if applicable 60, 70′, 80 and 90 are carried out repeatedly.

In the case that the deviation by contrast exceeds the predetermined threshold value, an outputting of a warning message, for example a visual and/or acoustic warning message takes place in 100.

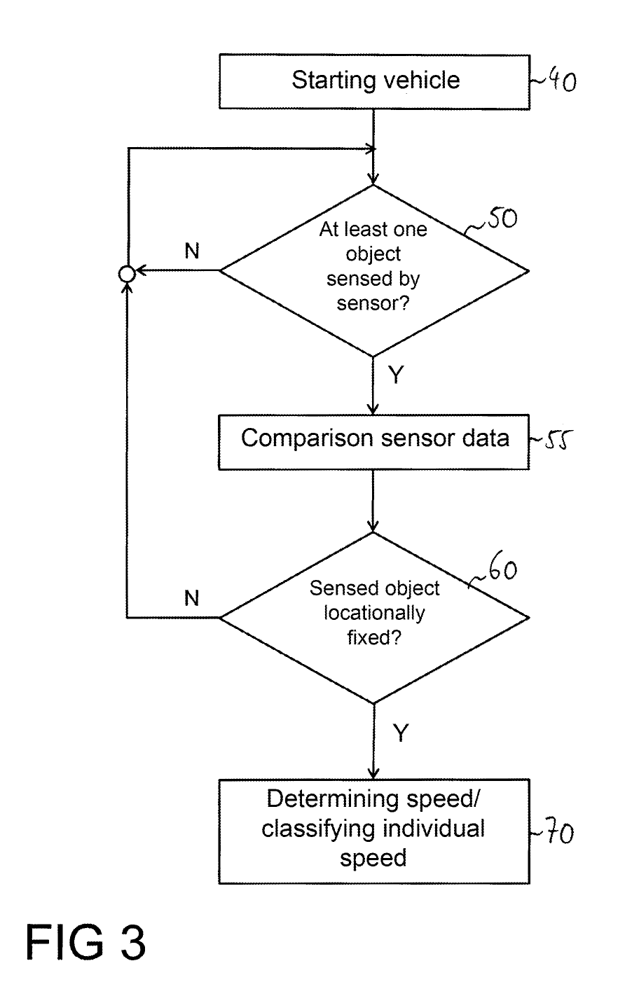

FIG. 3 shows a flow diagram of a method for determining a speed of a vehicle according to another exemplary embodiment of the present disclosure. Here, the vehicle is for example again a motor vehicle, in one example a passenger car.

In the shown exemplary embodiment, a starting of the vehicle in connection with an activating of at least one sensor and at least one optical camera takes place in 40, corresponding to 40 of the exemplary embodiment shown in FIG. 1.

In 50 it is determined if at least one object is sensed by the at least one sensor, corresponding to 50 of the exemplary embodiment shown in FIG. 1.

In the case that no object is sensed by the sensor, 50 is carried out repeatedly.

If by contrast at least one object is sensed by the sensor, a comparing of the sensing data of the at least one sensor and of the at least one optical camera takes place in 55. In the process, a direction and/or a distance of the at least one sensed object relative to the vehicle is determined by means of data determined by the at least one sensor and by means of the at least one optical camera and a fusion of the data and a mutual plausibility audit carried out. Because of this, an unambiguous allocation of the sensed object based on the determined sensor data can take place.

In 60 it is determined if the at least one sensed object is locationally fixed. This takes place by means of data determined by the at least one optical camera, corresponding to 60 of the exemplary embodiment shown in FIG. 1.

In the case that it is determined that the sensed object is not locationally fixed, 50 and if applicable 55 and 60 are carried out repeatedly.

If by contrast it is determined in 60 that the sensed object is locationally fixed, a determining of a speed of the sensed object relative to the vehicle by means of data determined by the at least one sensor and a classifying of the determined speed as individual speed of the vehicle takes place in 70, corresponding to 70 of the exemplary embodiment shown in FIG. 1.

By means of the shown exemplary embodiments, the individual vehicle speed can thus be determined in an advantageous manner by means of environment sensor or surroundings sensor devices implemented in the vehicle. This speed can be utilized for different systems, such as for example the indirect tire pressure measurement as reference to the currently determined speed in order to determine in one example the pressure drop in the tires of the vehicle.

With the help of the fusion of for example radar and camera environment data the individual vehicle speed is determined here. The vehicle speed obtained because of this can be utilized as redundant variable for different systems in the vehicle such as for example the indirect tire pressure measurement. The redundant variable is particularly advantageous since the speed present in the vehicle is typically based on the wheel speed and this variable is dependent on many influence factors. This is utilized for example with the tire pressure measurement in order to determine the pressure drop in the tire by means of a redundant speed variable. Here, a current circumference or radius of the tire and from this a pressure currently prevailing in the tire can be determined based on the redundant speed variable.

The speed can be determined very accurately in one example through the radar since the latter through the Doppler effect can achieve a very accurate speed determination. In the process, the radar system measures the relative speed to an object for example a vehicle, a road sign and/or a traffic light. The achieved accuracy for example is approximately 0.1 m/s.

In order to ensure in the process that the achieved or determined speed represents the individual vehicle speed, the speed component of the other object is taken into account. This can be achieved by fusing the data with camera data, in that only stationary objects for example traffic signs and/or parking vehicles are monitored. In an advantageous manner, the camera system can detect stationary objects and only monitor these.

Thus, the shown exemplary embodiments make possible the provision of a new method for determining the individual vehicle speed. The speed determined in such a manner in this case is independent of the speed determined by the wheel speeds and can improve systems such as for example the indirect tire pressure measurement. So-called TPMS systems (tire pressure monitoring systems) based on wheel rotational speed signals typically reach a relative accuracy of about 1.5% to about 2.5%. In one example from an individual speed of typically about 5.5 m/s or about 20 km/h, the methods according to the present disclosure are significantly more precise.

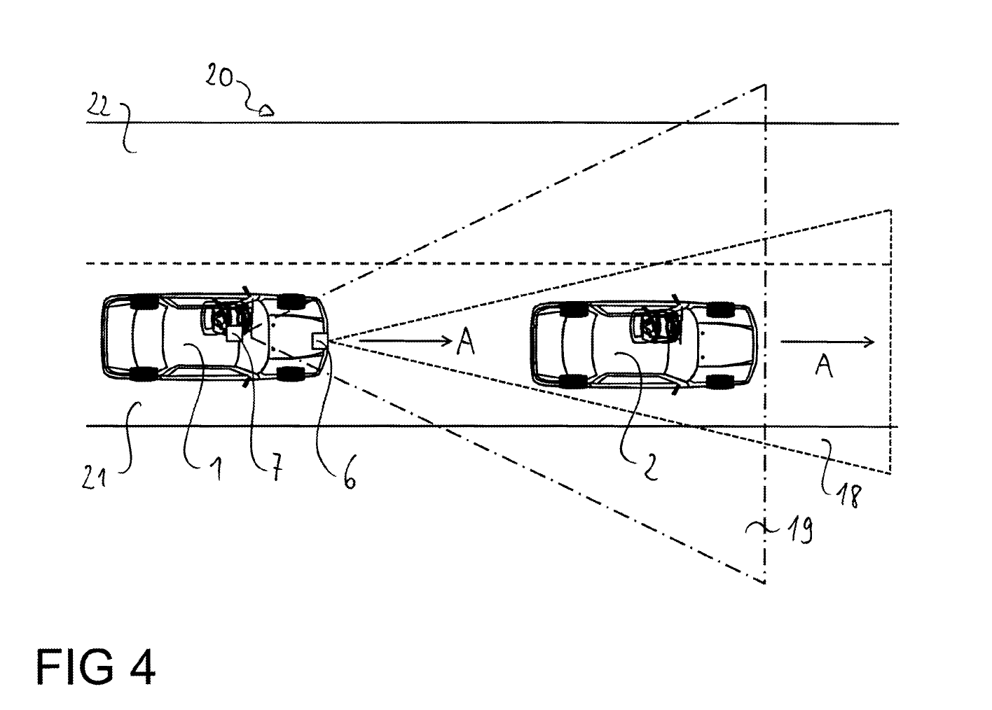

FIGS. 4 to 6 show examples of traveling situations, in which the method according to the exemplary embodiments of the present disclosure, in one example the methods according to the exemplary embodiments shown in the FIGS. 1 to 3 can be employed. Components with the same functions in this case are marked with the same reference characters.

In the traveling situation shown in FIG. 4 a vehicle 1, which in the shown situation is a passenger car, travels in a traveling direction represented by means of an arrow A on a first lane 21 of a road 20. In addition to the first lane 21, the road 20 additionally has a further lane 22.

The vehicle 1 comprises at least one sensor 6, which is generally selected from the group comprising a radar sensor, a lidar sensor and an ultrasound sensor. The sensor 6 in this case is designed for sensing objects within a sensing range 18 schematically represented by means of an interrupted line. In addition, the vehicle 1 comprises a visual camera 7 which is designed for sensing objects within a sensing range 19 schematically represented by means of a dash-dotted line.

In the shown traveling situation, an object 2 in the form of a further passenger car, which in traveling direction of the vehicle 1 travels in front of the latter on the lane 21 and likewise in the traveling direction of the vehicle 1, is located within the sensing ranges 18 and 19. Thus, the object 2 can be sensed by the sensor 6 and by the optical camera 7 and by means of data determined by the optical camera 7 it can be determined if the sensed object 2 is locationally fixed. In the shown traveling situation, the object 2 in the form of the passenger car is not stationary and is thus not utilized for a determining of the speed of the vehicle 1.

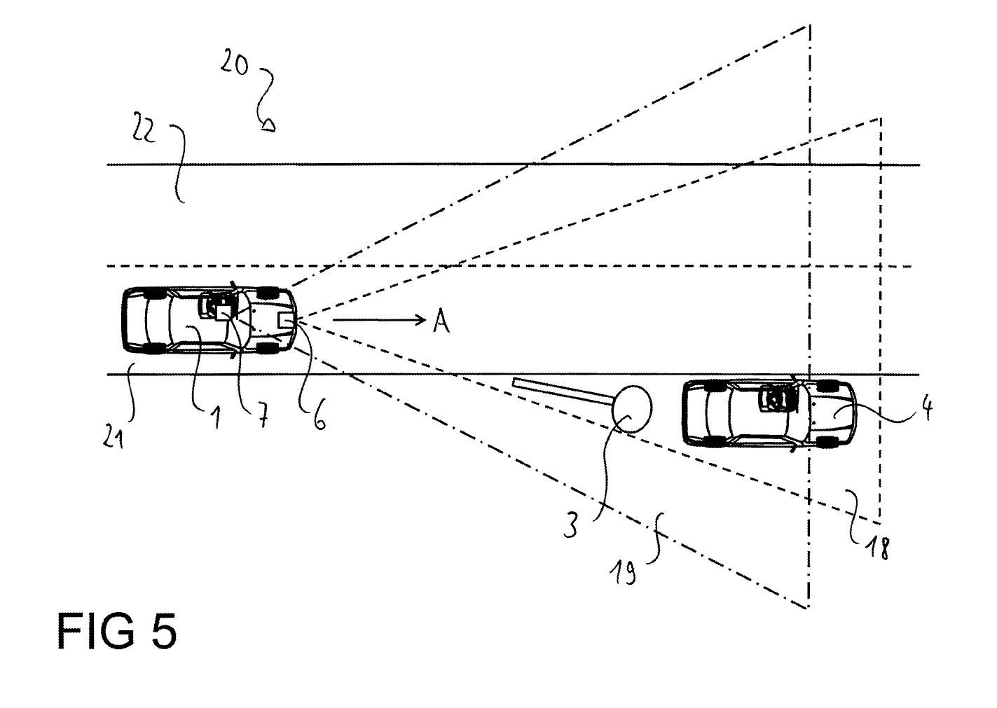

In the traveling situation shown in FIG. 5, the vehicle 1 again travels in the traveling direction schematically represented by means of an arrow A on the first lane 21 of the road 20. Adjacent to the first lane 21 an object 3 in the form of a traffic sign and an object 4 in the form of a stationary or parked passenger car is located next to the road 20. Here, the objects 3 and 4 are at least partially within the sensing ranges 18 and 19. By means of data determined by the optical camera 7 of the vehicle 1 the objects 3 and 4 can be classified as stationary and a speed of the vehicle 1 relative to the sensed objects 3 and 4, which is determined by means of data determined by the at least one sensor 6, be classified as individual speed of the vehicle 1.

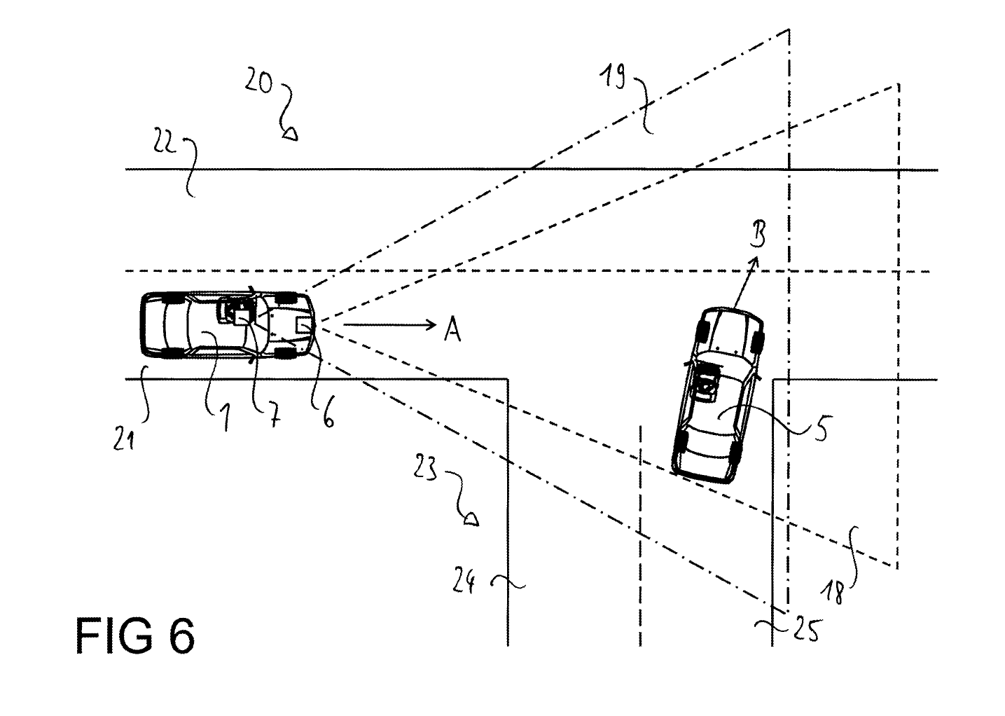

In the traveling situation shown in FIG. 6, the vehicle 1 again travels in the traveling direction schematically represented by means of an arrow A on the first lane 21 of the road 20. In traveling direction of the vehicle 1 an intersection is located in front of said vehicle, in which a road 23, comprising the lanes 24 and 25, leads into the road 20.

Here, in the shown situation, a further passenger car forming an object 5 travels in a traveling direction schematically represented by means of an arrow B from the lane 25 of the road 23 onto the lane 21 of the road 20. The object 5 in the form of the passenger car is again located within the sensing range 18 and 19, as a result of which data by means of the optical camera 7 of the vehicle 1 the object 5 can be classified as not stationary. Thus, the object 5 is not utilized for a determining of the individual speed of the vehicle 1.

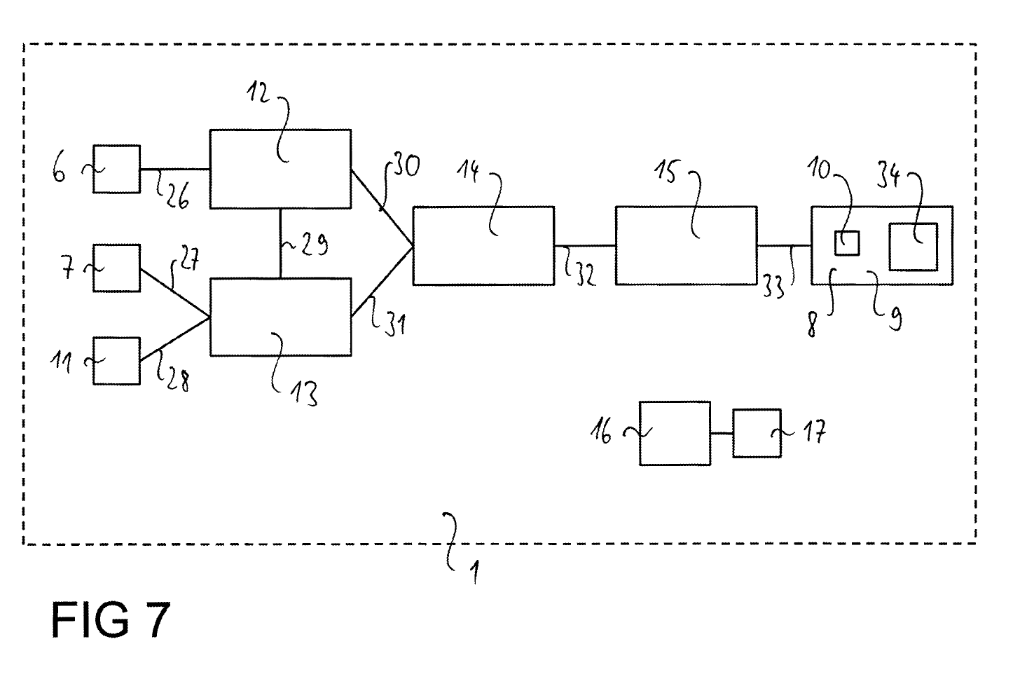

FIG. 7 shows a schematic representation of a vehicle 1 according to an exemplary embodiment of the present disclosure.

The vehicle 1 comprises a first determining device 12, which is designed for determining if at least one object is sensed by at least one sensor 6 of the vehicle 1. To this end, the first determining device 12 is connected to the sensor 6 via a signal line 26. The sensor 6 in this case is generally selected from the group comprising a radar sensor, a lidar sensor and an ultrasound sensor.

In addition, the vehicle 1 comprises at least one optical camera 7 and a second determining device 13, wherein the second determining device 13 is designed for determining if an object sensed by the at least one sensor 6 is locationally fixed, by means of data determined by the at least one optical camera 7. To this end, the second determining device 13 is connected via a signal line 27 to the optical camera 7 and via a signal line 29 to the first determining device 12. The second determining device 13 in this case is additionally designed, in the shown exemplary embodiment, for determining if a sensed object is locationally fixed by means of data received from a vehicle-to-infrastructure communication device 11. To this end, the second determining device 13 is connected to the vehicle-to-infrastructure communication device 11 via a signal line 28.

Furthermore, the vehicle 1 comprises a third determining device 14, which is designed for determining a speed of the at least one sensed object relative to the vehicle 1 by means of data determined by the at least one sensor 6. To this end, the third determining device 14 is connected to the first determining device 12 via a signal line 30 and to the second determining device 13 via a signal line 31.

In addition to this, the vehicle 1 comprises a classifying device 15 which is designed for classifying the determined speed as individual speed of the vehicle 1 in the case that it is determined that the at least one sensed object is locationally fixed. The classifying device 15 in this case is connected to the third determining device 14 via a signal line 32.

Furthermore, the classifying device 15 in the shown exemplary embodiment is designed for providing the determined speed for at least one driver assistance system 8 of the vehicle 1. The classifying device 15 to this end is connected via a signal line 33 to the driver assistance system 8, which in the shown exemplary embodiment is designed as tire pressure monitoring system 9. The tire pressure monitoring system 9 in this case comprises at least one rotational speed sensor 10 of a tire of the vehicle 1 which is not shown in more detail in FIG. 7 and is designed for determining a speed of the vehicle 1 based on the data determined by the rotational speed sensor 10. If a deviation between the speed determined by means of the at least one sensor 6 and the speed determined by means of the rotational speed sensor 10 exceeds a predetermined threshold value, a warning message, for example a visual and/or acoustic warning message is output in the shown exemplary embodiment by means of an output device 34 of the tire pressure monitoring system 9.

In the shown exemplary embodiment, the vehicle 1 additionally comprises a computer unit 16 and a computer-readable medium 17, wherein on the computer-readable medium 17 a computer program product is stored which, when it is executed on the computer unit 16, instructs the computer unit 16 to carry out the method mentioned in connection with the exemplary embodiments of the present disclosure, in one example the exemplary embodiment shown in FIGS. 1 to 3 by means of the elements mentioned there. To this end, the computer unit 16 is directly or indirectly connected to the corresponding elements in a manner that is not shown in more detail.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for determining a speed of a vehicle, comprising:
determining if at least one object is sensed by at least one sensor of the vehicle;
in the case that at least one object is sensed by the at least one sensor, determining if the at least one sensed object is locationally fixed, by means of data determined by at least one optical camera of the vehicle; and
in the case that it is determined that the at least one sensed object is locationally fixed, determining a speed of the at least one sensed object relative to the vehicle by means of data determined by the at least one sensor and classifying of the determined speed as individual speed of the vehicle.

2. The method according to claim 1, wherein the at least one sensor is selected from the group comprising a radar sensor, a lidar sensor and an ultrasound sensor.

3. The method according to claim 1, wherein the determining if the at least one sensed object is locationally fixed, further comprises:
evaluating images taken by means of the at least one optical camera.

4. The method according to claim 3, wherein evaluating images further comprises:
determining at least one of a size and a change of the size of the at least one object in the images taken by the at least one optical camera.

5. The method according to claim 1, wherein the determined speed is provided for at least one driver assistance system of the vehicle.

6. The method according to claim 5, wherein the at least one driver assistance system is selected from the group comprising a tire pressure monitoring system, a park assist system, a brake assist, an emergency braking, a speed control system and a distance control system.

7. The method according to claim 6, wherein the at least one driver assistance system is designed as tire pressure monitoring system and the method further comprises:
determining of a speed of the vehicle based on data determined by at least one rotational speed sensor of a tire of the vehicle.

8. The method according to claim 7, further comprising:
outputting a warning message in the case that a deviation between the speed determined by means of the at least one sensor and the speed determined by means of the at least one rotational speed sensor exceeds a predetermined threshold value.

9. The method according to claim 3, further comprising:
determining at least one of a direction and a distance of the at least one sensed object relative to the vehicle by means of data determined by the at least one sensor and the at least one optical camera; and
auditing the determined data for plausibility.

10. The method according claim 1, wherein the determining if the at least one sensed object is locationally fixed, further comprises:
determining if the at least one sensed object is locationally fixed on data received from at least one of a vehicle-to-infrastructure communication device and a vehicle-to-vehicle communication device.

11. A vehicle, comprising:
a first determining device that determines if at least one object is sensed by at least one sensor of the vehicle;
at least one optical camera;
a second determining device that determines if a sensed object is locationally fixed, by means of data determined by means of the at least one optical camera, in the case that at least one object is sensed by the at least one sensor;
a third determining device that determines a speed of the at least one sensed object relative to the vehicle by means of data determined by the at least one sensor; and
a classifying device that classifies the determined speed as individual speed of the vehicle in the case that it is determined that the at least one sensed object is locationally fixed.

12. The vehicle according to claim 11, wherein the at least one sensor is selected from the group comprising a radar sensor, a lidar sensor and an ultrasound sensor.

13. The vehicle according to claim 11, further comprising:
at least one driver assistance system selected from the group comprising a tire pressure monitoring system, a park assist system, a brake assist, an emergency braking system, a speed control system and a distance control system,
wherein the at least one driver assistance system operates based on the determined speed.

14. A computer program product, comprising:
a non-transitory computer readable medium readable by a computer unit of a vehicle and storing instructions for execution by the computer unit for performing a method comprising:
determining if at least one object is sensed by at least one sensor of the vehicle;
in the case that at least one object is sensed by the at least one sensor, determining if the at least one sensed object is locationally fixed by means of data determined by at least one optical camera of the vehicle; and
in the case that it is determined that the at least one sensed object is locationally fixed, determining a speed of the at least one sensed object relative to the vehicle by means of data determined by the at least one sensor and classifying of the determined speed as individual speed of the vehicle.

15. The computer program product according to claim 14, wherein the determining if the at least one sensed object is locationally fixed, further comprises: evaluating images taken by means of the at least one optical camera.

16. The computer program product according to claim 15, wherein evaluating images further comprises:
determining at least one of a size and a change of the size of the at least one object in the images taken by the at least one optical camera.

17. The computer program product according to claim 14, wherein the determined speed is provided for at least one driver assistance system of the vehicle.

18. The computer program product according to claim 17, wherein the at least one driver assistance system is designed as tire pressure monitoring system and the method further comprises:
determining of a speed of the vehicle based on data determined by at least one rotational speed sensor of a tire of the vehicle.

19. The computer program product according to claim 18, further comprising:
outputting a warning message in the case that a deviation between the speed determined by means of the at least one sensor and the speed determined by means of the at least one rotational speed sensor exceeds a predetermined threshold value.
